(19) United States
(12) Patent Application Publication
(10) Pub. No.: US 2005/0200211 A1
(43) Pub. Date: Sep. 15, 2005

(54) Spindle motor and stator structure thereof

(75) Inventors: Chin-Chu Hsu, Taoyuan (TW); Chia-Ching Weng, Taoyuan (TW); Tsung-Ju Yang, Taoyuan (TW)

Correspondence Address: BIRCH STEWART KOLASCH & BIRCH, PO BOX 747, FALLS CHURCH, VA, 22040-0747, US

(73) Assignee: Delta Electronics, Inc.

(21) Appl. No.: 11/007,191

(22) Filed: Dec. 9, 2004

(30) Foreign Application Priority Data
Mar. 15, 2004 (TW) 93106820

(51) Int. Cl. H02K 5/24; H02K 7/00

(52) U.S. Cl. 310/51; 310/67 R

(57) ABSTRACT

A spindle motor includes a stator structure and a rotor structure enclosing the stator structure. The stator structure has a stator base, a magnetic conductive structure surrounding the stator base, and a buffer structure provided in the gap defined by the stator base and the magnetic conductive structure and in contact with both the stator base and the magnetic conductive structure.

### BACKGROUND OF THE INVENTION

(a) Field of the Invention

The present invention relates to a spindle motor and stator structure thereof and, more particularly, to a spindle motor and stator structure thereof having reduced vibrations and noises during operation.

(b) Description of the Related Art

Referring to FIG. 1, a conventional spindle motor 100 includes a rotor 102 and a stator 104 riveted on a base 110. The stator 104 consists of silicon steel sheets 106 and a stator base 108, which are riveted together.

However, when the spindle motor 100 runs, the silicon steel sheets 106 is liable to vibrate due to the attraction of the rotor 102. In that case, since no damping mechanism is incorporated in the stator structure 104 of the conventional spindle motor 100, such vibrations are transmitted to the base 110 through the stator base 108. Further, because the silicon steel sheets 106, the stator base 108, and the base 110 are riveted together, there must be gaps existing among them. Under the circumstance, the gaps may further enhance the vibrations of the silicon steel sheets 106, the stator base 108, and the base 110, and thus the noises made by the spindle motor 100 are considerably increased as a result.

### BRIEF SUMMARY OF THE INVENTION

In view of this, an object of the invention is to provide a spindle motor having reduced vibrations and noises during operation.

According to the invention, A spindle motor includes a stator structure and a rotor structure enclosing the stator structure. The stator structure has a stator base, a magnetic conductive structure surrounding the stator base, and a buffer structure provided in the gap defined by the stator base and the magnetic conductive structure and in contact with both the stator base and the magnetic conductive structure.

Through the design of the invention, since the stator base and the magnetic conductive structure are connected by the buffer structure, which can absorb the vibrations resulting from the rotation of the rotor structure and prevent it from being transmitted to the stator base and the base plate, the vibrations and noises are considerably reduced as the spindle motor runs

### BRIEF DESCRIPTION OF THE DRAWINGS

FIG. 1 is a schematic diagram illustrating a conventional spindle motor.

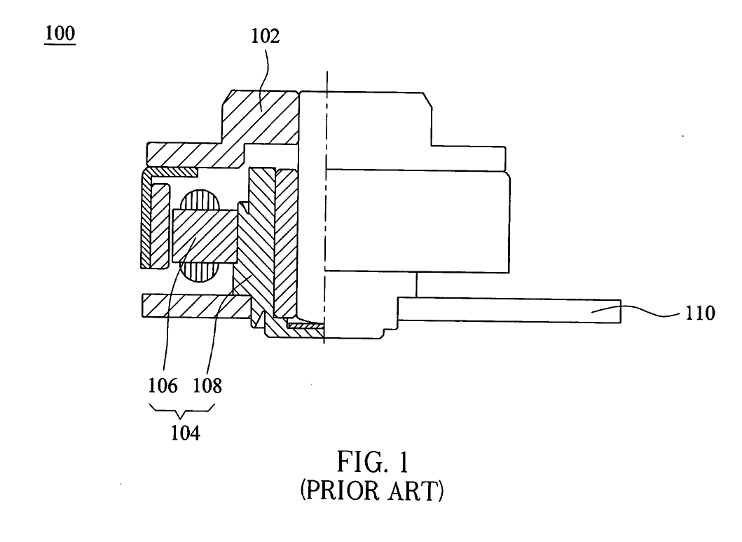

FIG. 2 is a schematic diagram illustrating a spindle motor according to an embodiment of the invention.

FIG. 3 is a schematic diagram illustrating a spindle motor according to another embodiment of the invention.

FIG. 4 is a schematic diagram illustrating a spindle motor according to another embodiment of the invention.

### DETAILED DESCRIPTION OF THE INVENTION

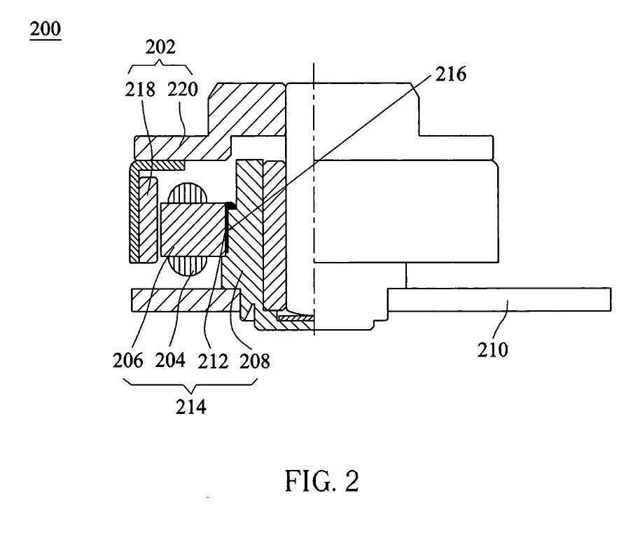

FIG. 2 illustrates a spindle motor 200 including a rotor structure 202 and a stator structure 214. The stator structure 214 includes a magnetic conductive structure 206 and stator base 208, and a gap 216 is defined therebetween by both of them. A buffer structure is provided in the gap 216 between the magnetic conductive structure 206 and the stator base 208.

The rotor structure 202, which includes a casing 220 and a magnetic structure 218 affixed to the underside of the casing 220, encloses the stator structure 214. The magnetic interaction induced between the stator structure 214 and the magnetic structure 218 of the rotor structure 202 causes the rotations of the rotor structure 202 and other structures linked to it, such as a blade, mounting plate and a disk. Inside the casing 220 a shaft (not shown) is located in its center and deeply inserted in the stator base 208 to allow the rotor structure 202 to rotate about it. The magnetic structure 218 may be a magnetic tape having more than two magnetic poles, with two adjacent poles being in opposite polarity. The casing 220 may be made of metal, plastic, or magnetic conductive materials.

The stator structure 214 includes a stator base 208, a magnetic conductive structure 206, a coil 204, and a buffer structure provided in the gap defined by the stator base 208 and the magnetic conductive structure 206 and in contact with both of them. In this embodiment, an adhesive substance 212 is employed in forming the buffer structure.

The stator base 208 has a cylindrical body extending in the axial direction of the spin motor 200, and the cylindrical body is used for accommodating the shaft. The magnetic conductive structure 206 is placed around the cylindrical body and formed with a plurality of magnetic poles whose number corresponds to the magnetic poles of the magnetic structure 218. The magnetic conductive structure 206 surrounding the stator base 208 may be connected to it. The coil 204 is wrapped around the magnetic conductive structure 206, so that the magnetic polarity and strength can be controlled by the direction and amplitude of the current flowing through the coil 204. The magnetic conductive structure 206 may be a silicon steel sheet, and the stator base 208 may be made of plastic, metal or a non-magnetic conductive material.

The adhesive substance 212 is filled in the gap 216 defined by the stator base 208 and the magnetic conductive structure 206 to form a connection. The adhesive substance 212 may fill the gap to the full or partially with cavities or bubbles remained therein, as long as the adhesive substance 212 both contacts the stator base 208 and the magnetic conductive structure 206. The adhesive substance 212 is filled in the gap by dispensing, filling, adhering, or engaging, and the adhesive substance 212 may be made of resin or an adhesive material.

There are several ways to assemble the adhesive substance 212, stator base 208 and the magnetic conductive structure 206 together. For example, the stator base 208 or the magnetic conductive structure 206 may be first covered with adhesive substance 212, and then the magnetic conductive structure 206 is mounted on the stator base 208. Alternatively, the adhesive substance 212 may be applied on both the stator base 208 and the magnetic conductive either before or after they have been assembled.

According to the invention, since the stator base 208 and the magnetic conductive structure 206 are connected by the adhesive substance 212, the adhesive substance 212 can absorb the vibration resulting from the rotation of the rotor structure 202 to prevent such vibration from being transmitted to the stator base 208 and the base plate 210. Therefore, as the spindle motor 200 runs, the vibrations and noises are considerably reduced.

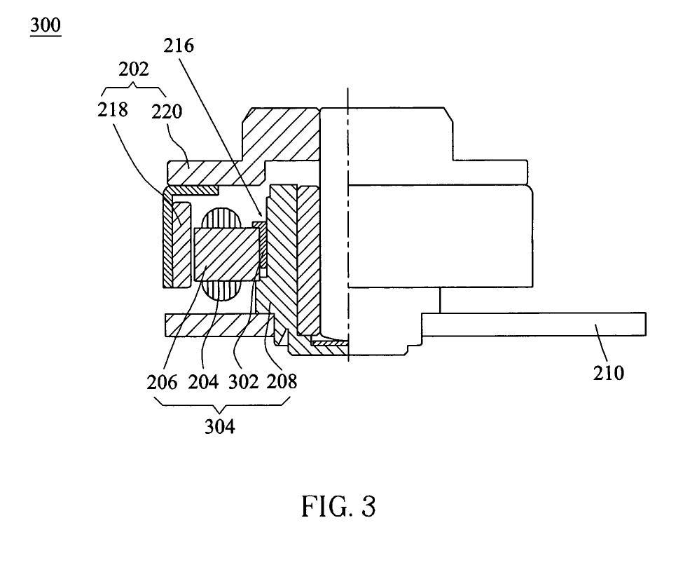

FIG. 3 illustrates a spindle motor 300 according to a second embodiment of the invention. This embodiment differs from the first embodiment in that the buffer structure in the stator structure 304 is a flexible member 302. The flexible member 302 may be made of rubber or elastic materials. The assembling methods for the flexible member 302, the stator base 208, and the magnetic conductive structure 206 are similar to those mentioned in the first embodiment, and thus such details are omitted in the description.

According to this embodiment, because the flexible member has high resilience, the buffer structure can absorb the vibrations and eliminate the noises more effectively

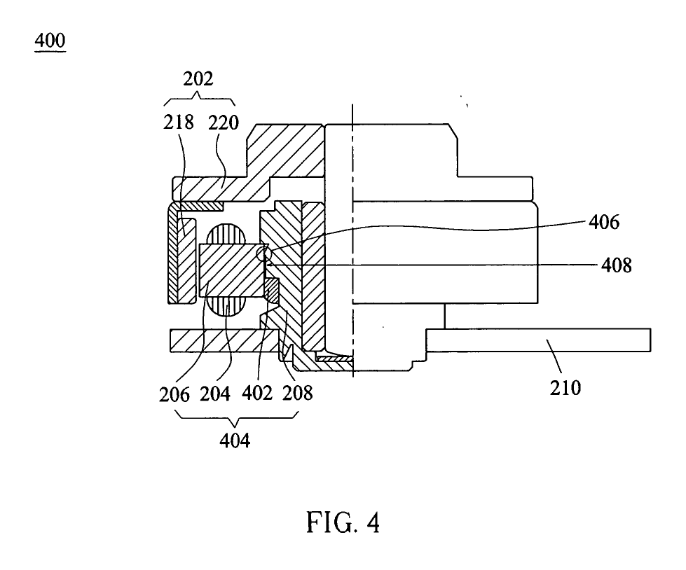

FIG. 4 illustrates a spindle motor 400 according to a third embodiment of the invention. The third embodiment differs from the aforesaid embodiments in that the buffer structure in the stator structure 404 is a filling substance 402, and that a positioning part 406 is formed between the stator base 208 and the magnetic conductive structure 206. The positioning part 406 may be either formed on the sidewall of the magnetic conductive structure 206 facing the stator base 208 or on the sidewall of the stator base 208 facing the magnetic conductive structure 206, or both.

Since the positioning part 406 is naturally formed as a projection, an additional engaging force is provided when the projection engages with the filling substance 402. The filling substance 402 may be made of foaming materials or filling materials. Further, the positioning part 406 may be in contact with both the magnetic conductive structure 206 and the stator base 208 to position them.

Also, the opening of the space 408 between the stator base 208 and the magnetic conductive structure 206 may be either face down (facing opposite to the rotor structure 202) or face up (facing towards the rotor structure 202), as shown in FIG. 4. As the opening of the space 408 is face down, the engaging force provided by the positioning part 406 can prevent the filling substance 402 from sliding off.

According to this embodiment, since the buffer structure is a filling substance, the buffer structure can absorb the vibrations and eliminate the noises more effectively. Also, the positioning part 406 that positions the magnetic conductive structure 206 and the stator base 208 may facilitate their alignment during assembly.

Although the buffer structures exemplified in the three foregoing embodiments are different, the use of these structures is not limited; in other words, structures in one embodiment can be applied in other embodiments. For example, the filling substance in the third embodiment can be replaced by the flexible member, the adhesive substance, or both.

Further, though the spindle motor 200 is exemplified as an outer-rotor motors, one having ordinary skill in the art should understand that this invention can also be implemented in an inner-rotor motor.

While the invention has been recited by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A spindle motor, comprising:
a stator structure, comprising:
a stator base;
a magnetic conductive structure connected to the stator base; and
a buffer structure provided in the gap defined by the stator base and the magnetic conductive structure and in contact with both the stator base and the magnetic conductive structure, wherein the material of the buffer structure is selected from the group consisting of a mixture of one or more of resin, rubber, foaming material, adhesive material, and filling material; and
a rotor structure enclosing the stator structure.

2. (canceled)

3. The spindle motor as recited in claim 1, wherein the sidewall of the stator base facing the magnetic conductive structure is formed with a positioning part.

4. The spindle motor as recited in claim 1, further comprising a positioning part which is in contact with both the stator base and the magnetic conductive structure.

5. The spindle motor as recited in claim 1, wherein the sidewall of the magnetic conductive structure facing the stator base is formed with a positioning part.

6. The spindle motor as recited in claim 1, wherein the stator base is surrounded by the magnetic conductive structure.

7. The spindle motor as recited in claim 1, wherein the opening of the gap defined by the stator base and the magnetic conductive structure faces opposite to the rotor structure.

8. The spindle motor as recited in claim 1, wherein the opening of the gap defined by the stator base and the magnetic conductive structure faces towards the rotor structure.

9. The spindle motor as recited in claim 1, wherein the buffer structure fills the gap to the full.

10. The spindle motor as recited in claim 1, wherein the buffer structure fills the gap partially with cavities or bubbles remained therein.

11. The spindle motor as recited in claim 1, wherein the buffer structure is filled in the gap by dispensing, filling, adhering, or engaging.

12. A stator structure, comprising:
a stator base;
a magnetic conductive structure connected to the stator base; and
a buffer structure provided in the space defined by the stator base and the magnetic conductive structure and in contact with both the stator base and the magnetic conductive structure, wherein the material of the stator structure is selected from the group consisting of a mixture of one or more of resin, rubber, foaming material, adhesive material, and filling material.

13. (canceled)

14. The spindle motor as recited in claim 12, wherein the sidewall of the stator base facing the magnetic conductive structure is formed with a positioning part.

15. The spindle motor as recited in claim 12, further comprising a positioning part which is in contact with both the stator base and the magnetic conductive structure.

16. The spindle motor as recited in claim 12, wherein the sidewall of the magnetic conductive structure facing the stator base is formed with a positioning part.

17. The spindle motor as recited in claim 12, wherein the stator base is surrounded by the magnetic conductive structure.

18. The spindle motor as recited in claim 12, wherein the opening of the space defined by the stator base and the magnetic conductive structure faces opposite to the rotor structure.

19. The spindle motor as recited in claim 12, wherein the opening of the space defined by the stator base and the magnetic conductive structure faces towards the rotor structure.

20. The spindle motor as recited in claim 12, wherein the buffer structure fills the space to the full.

21. The spindle motor as recited in claim 12, wherein the buffer structure fills the space partially with cavities or bubbles remained therein.

22. The spindle motor as recited in claim 12, wherein the buffer structure is filled in the space by dispensing, filling, adhering, or engaging.

23. A stator structure, comprising:
a stator base;
a magnetic conductive structure connected to the stator base;
a positioning part located between the stator base and the magnetic conductive structure and in contact with both the stator base and the magnetic conductive structure; and
a buffer structure provided in the space defined by the stator base and the magnetic conductive structure and in contact with both the stator base and the magnetic conductive structure, wherein the positioning part engages with the buffer structure.
